(19) United States
(12) Patent Application Publication
(10) Pub. No.: US 2025/0026909 A1
(43) Pub. Date: Jan. 23, 2025

(54) TIRE FORMULATION WITH BIO-WASTE MATERIAL

(71) Applicant: FCA US LLC, Auburn Hills, MI (US)

(72) Inventors: Sathishkumar Murugesan, Salem District (IN); Shweta Kulkarni, Pune (IN)

(21) Appl. No.: 18/356,450

(22) Filed: Jul. 21, 2023

(51) Int. Cl. C08K 3/22; C08K 3/04; C08K 3/36; C08K 5/09; C08K 5/548; C08L 7/00; C08L 9/06

(52) U.S. Cl. CPC C08K 3/22; C08K 3/04; C08K 3/36; C08K 5/09; C08K 5/548; C08L 7/00; C08L 9/06; C08K 2003/0893; C08K 2003/2206; C08K 2201/011; C08K 2201/014

(57) ABSTRACT

A formulation for a tire comprising natural rubber and synthetic rubber, a silane coupling agent and a lubricant. The tire tread formulation may further comprise a curing agent, a plasticizer, a cross-linking agent, an accelerator system, a pre-vulcanization inhibitor and a bio-waste material, such as calcium oxide which may be obtained from egg shells, is also provided.

### FIELD

The present disclosure relates to use of bio-waste material in a tire formulation.

### BACKGROUND

Over recent years, due to the growing commitments to green transportation, certain regulations require improvement in rolling resistance, wet grip and rolling sound emission in vehicle tires. The performance in tires has gained many concerns, especially in tire treads. Conventionally, tire designers attempt to make formulations to balance a number of competing design requirements, balancing of rolling resistance, wet grip or traction, and wear or abrasion resistance. Many trade-offs between these three properties are considered when designing a tire tread.

Rolling resistance, sometimes called rolling friction is the force resisting the motion when a body rolls on a surface. It is mainly caused by non-elastic effects; that is, not all the energy needed for deformation of the wheel, roadbed, etc. is recovered when the pressure is removed. Two forms of this are hysteresis losses and permanent deformation of the object or the surface. Another cause of rolling resistance lies in the slippage between the wheel and the surface, which dissipates energy.

When a vehicle is in motion, a vertical load acts on the tires. This vertical load creates the moment in the opposite direction of tire rotation. This is called rolling resistance, which is represented by:
Tan Delta (Tan δ)=Viscous component/Solid component.

Tan Delta is considered as a lab predictor for the tire rolling resistance and is used in lab evaluations of tire treads and their formulation.

Passenger vehicle tire treads may include fillers such as carbon black and silica. In some formulations, silica has been used as a replacement for some or all the carbon black. The use of relatively large amounts of silica, however, also may have some drawbacks, particularly in connection with the environment when liberated during use of the tire. Silica dust may be a pollutant, and may cause problems with plants as well as humans. As tires wear, carbon black may be released and can be detrimental to human respiratory function.

Accordingly, it may be beneficial to provide a sustainable approach of reducing tire tread rolling resistance by systematic lab evaluation. More specifically it may be beneficial to replace some or all of the silica in a tire tread formulation with a chemical derived from bio-waste material. One such material may comprise calcium oxide, CaO, derived from the calcination of egg shells.

### SUMMARY

In at least some implementations, there is provided a tire formulation comprising natural rubber and synthetic rubber. The tire formulation further comprises a silane coupling agent and a lubricant. The tire formulation further comprises a curing agent, a plasticizer, and a cross-linking agent. The tire formulation further comprises and accelerator system and a pre-vulcanization inhibitor. A filler derived from a bio-waste material is also provided.

In at least some implementations, there is provided a tire tread formulation comprising natural rubber and synthetic rubber. The tire tread formulation further comprises carbon black, a silane coupling agent and a lubricant. The tire tread formulation further comprises a curing agent, a plasticizer, and a cross-linking agent. The tire tread formulation further comprises and accelerator system and a pre-vulcanization inhibitor. The tire tread formulation further comprises a filler derived from the calcination of eggs.

In at least some implementations, there is provided a method of preparing a formulation for a tire. The method comprises mixing a natural rubber, a synthetic rubber, carbon black, a silane coupling agent, a lubricant, a curing agent, a plasticizer, a cross-linking agent, an accelerator system, a pre-vulcanization inhibitor, and a filler derived from a bio-waste material. The method further comprises forming the mixed tire formulation into a continuous slab by passing the mixed tire tread formulation through rollers. Processing parameters comprising the duration for each stage, pressure, nip gap, speed of the rollers, their ratio, or combinations of these are controlled.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 depicts a three-dimensional triangle showing the balancing of some considerations for a tire tread formulation; and

FIG. 2 is a flow chart showing the bio-waste processing steps.

### DETAILED DESCRIPTION

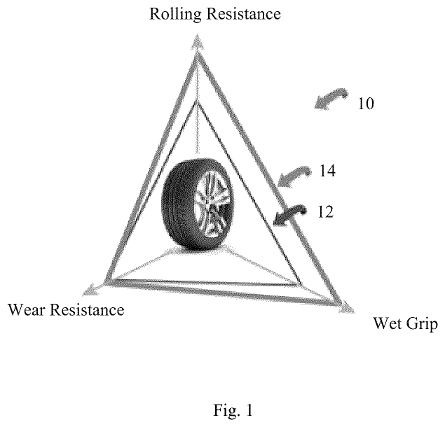

Referring in more detail to the drawings, FIG. 1 shows a three-dimensional triangle, generally indicated at 10, which represents competing design requirements for tire treads by showing the balancing of three tire tread properties, namely, rolling resistance, wet grip or traction, and wear or abrasion resistance each of which are important considerations when formulating a formulation to be used for tire treads. Different formulations of tire material will typically affect these three properties either positively or negatively. As shown in FIG. 1, the three outwardly directed arrows, pointing toward Rolling Resistance, Wear Resistance and Wet Grip represent an improvement of the respective properties of the tire. A tire is also shown inside the triangle which depicts the position of the tire tread properties inside of the triangle.

Tire tread formulations may comprise natural and synthetic rubbers, and fillers. Carbon black and silica may be used as fillers in a tire tread formulation. Carbon black can be used both as a pigment and to improve the wear resistance of the tires. Both carbon black and silica may present issues of environmental concern and it is desirable in at least some applications to use a lesser amount of at least one of these fillers without degrading the tire tread properties.

The tire tread formulation of an embodiment comprises natural and synthetic rubber. The natural rubber comprises polyisoprene. The synthetic rubber comprises styrene, butadiene, polybutadiene, or combinations of each of these. The use of a combination of natural and synthetic rubber improves the low-temperature performance, rolling resistance, and wear resistance of a tire tread. The amounts of natural and synthetic rubbers may be optimized to provide the most desirable tire tread properties while minimizing the effect of wet grip.

The tire tread formulation further includes fillers which may include carbon black and silica, which may be widely dispersed. As set forth above these fillers may benefit the rolling resistance and/or the wet grip of the tire tread. When silica is added to a tire tread formulation, the rubber content may increase to balance the three properties of the magic triangle.

The tire tread formulation also comprises a silane coupling agent. The combination of silica and a silane coupling agent improves the rolling resistance and wet grip of the tire tread. The silane coupling agent contains functional groups capable of linking both the rubber and the silica. The silane coupling agent may comprise bis-(triethoxysilylpropyl) tetrasulfide (TESPT) and the corresponding disulfide (TESPD). It will be appreciated that other silane coupling agents may be used. It is believed that the silane coupling agent reacts first with the silanol groups of the silica filler, forming a hydrophobic shell around the filler particle and improving the compatibility between the filler and the rubber. The sulfur moiety may then react with the rubber to form of a stable network between the silica filler and the rubber polymer.

Because the components of the tire tread are mechanically mixed, a lubricant may be included. More particularly, during processing of rubbers the components need to be masticated in grinding/mixing machines which results in the generation of heat. This generation of heat may be due to internal friction between individual components. One such rubber lubricant that may be used in the formulation is IPOL RUBBER OIL 701, which is an aromatic that helps lubricate the various components reducing the mixing temperature and the load on the mixers/blenders IPOL RUBBER OIL 701 may also facilitate the introduction of various additives into the formulation. It will be appreciated, however, that any suitable lubricant may be used.

The tire tread formula further includes sulfur, which is a cross-linking agent, and a curing agent. Sulfur is used to help cure, or vulcanize, the formula. The curing agent is also used to help the vulcanization process. One suitable curing agent comprises zinc oxide (ZnO). In addition, stearic acid may be combined with zinc oxide. Zinc oxide and stearic acid together, improve the solubility of zinc oxide in the formula, and with the accelerator, described below, forms a complex, that reacts with sulfur to produce a vulcanizing agent.

Because sulfur alone is relatively slow at curing the rubber components, an accelerator system may also be employed. Accelerator systems are known and may comprise thiocarbamates, thiazoles, sulfenamides, thiuram sulfide phenols, guanidines, amines, or combinations of these. It will be appreciated, however that any suitable accelerator system may be used.

The tire tread formula further comprises a plasticizer. Plasticizers are used to soften the rubber, as is known. It will be appreciated that any suitable plasticizer may be used.

The tire tread formulation may further include a pre-vulcanization inhibitor. A pre-vulcanization inhibiter or retarder is used to avoid premature vulcanization during processing. Such a retarder reacts with the accelerator and only slowly release them. Pre-vulcanization inhibiters are known, and any suitable pre-vulcanization inhibiter may be used.

The tire tread formulation may further include an anti-ozonate and an anti-oxidant. Anti-ozonates are employed to protect the composition from the detrimental effects of ozone. Anti-oxidants are employed to protect the composition from the detrimental effects of oxygen. It will be appreciated that any suitable anti-ozonate and anti-oxidant may be used in the tire tread formulation.

As set forth above, current tire tread formulations may include fillers including carbon black and silica. Each of which offers beneficial properties to the tire tread, but also may detrimental environmental effects on the environment. As shown in FIG. 1, the three-dimensional triangle generally shows tire tread properties, namely, rolling resistance, wet grip, and wear resistance for a tire filled with carbon black and silica at 12 and is depicted by the triangle having relatively thinner lines. In order to improve some of the tire tread properties, as well as lessen the environmental impact of the tire treads, an embodiment uses a filler derived from a bio-waste material. More specifically, the filler comprises calcium oxide (CaO) derived from egg shells. The addition of calcium oxide increases both the rolling resistance and wet grip of the tire tread, and this increase is depicted by the triangle 14 in FIG. 1. Calcium oxide can be used to replace all or some of the filler material in the formula. In an embodiment, the calcium oxide replaces some or all of the silica.

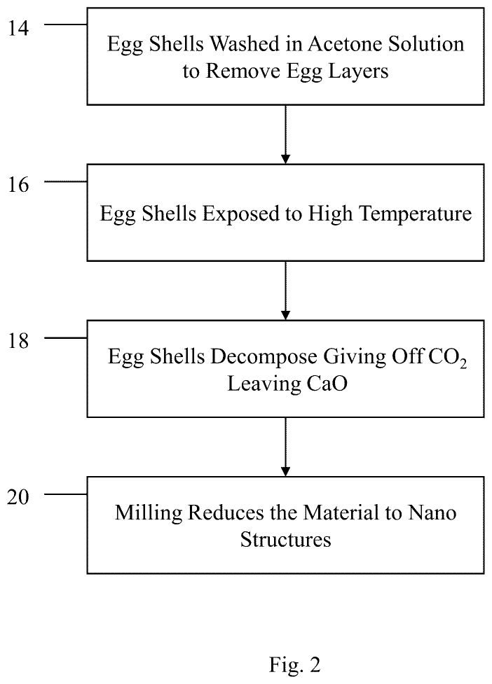

Hen egg shells are made almost entirely, in excess of 90%, of calcium carbonate (CaCo₃). As shown in FIG. 2, Calcium oxide (CaO) can be produced by the calcination of egg shells. In an embodiment, to calcify the egg shells, in step 15, the egg shells are first washed in an acetone solution to remove any egg layers. In step 16, the shells are then exposed to relatively high temperatures, and in an embodiment at least 900° C. At and above this temperature, in step 18, the eggs decompose giving off carbon dioxide (CO₂) and leaving CaO, which is a white solid. It will be appreciated, however, that the temperature for calcification of the egg shells may take place at any suitable temperature that decomposes the egg shells by giving off CO₂ and leaving CaO. The CaO then undergoes milling in step 20, to reduce the material to nano structures. During processing of the bio-waste material, the bio-derived CaO is treated to get the same or approximately the same specific surface area as carbon black and or silica. The CaO from step 20 is used in the formulation as a filler, replacing some or all of the carbon black and silica, to improve both the rolling resistance and wet grip of the tire tread, and to reduce the negative effects the tire tread may have on the environment. In addition, this formulation using CaO may give rise to a fuel savings of approximately 3% corresponding to a 20% rolling resistance compared to tires with carbon black reinforced tires.

Further, the ratio of natural rubber to synthetic rubber may be adjusted to achieve beneficial properties of the rolling resistance, wear resistance and wet grip. Further yet, the type of cure system chosen may be different depending on the final tire tread formulation. Such cure system may be a conventional system, a semi-efficient system, or an efficient system. These cure systems differ in the sulfur concentrations and in the accelerator to sulfur ratio, as is known.

Mixing of the tire tread formulation may be done in a batch operation and may be conventional, late oil addition or upside down, as are known. The processing type may be based on the tire tread formulation having the bio-derived CaO. The mixing may take place in stages and the cure system may be added in the final stage of mixing. After mixing, the tire tread formulation is formed into a continuous slab and during such formation, the tire batch may pass through a mill which comprises counter-rotating rollers that are spaced apart to form a nip. Processing parameters such as duration for each stage, temperature, pressure, nip gap, speed of the rollers and their ratio, or combinations of some or all of these processing parameters are selected and/or controlled so as to provide a desired balance for tire tread performance.

What is claimed is:

1. A tire formulation comprising:
natural rubber;
synthetic rubber;
a silane coupling agent;
a lubricant;
a curing agent;
a plasticizer;
a cross-linking agent;
an accelerator system;
a pre-vulcanization inhibitor; and
a filler derived from a bio-waste material.

2. A tire formulation as set forth in claim 1 wherein the filler derived from a bio-waste material comprises CaO derived from the calcination of egg shells.

3. A tire formulation as set forth in claim 2 further including carbon black.

4. A tire formulation as set forth in claim 3 further including silica.

5. A tire formulation as set forth in claim 2 wherein the natural rubber comprises polyisoprene.

6. A tire formulation as set forth in claim 2 wherein the synthetic rubber comprises at least one of styrene butadiene rubber or polybutadiene or combinations thereof.

7. A tire formulation as set forth in claim 2 wherein the silane coupling agent comprises at least one of bis-(triethoxysilylpropyl) tetrasulfide (TESPT) or the corresponding disulfide (TESPD) or combinations thereof.

8. A tire formulation as set forth in claim 2 wherein the lubricant comprises an aromatic rubber processing oil.

9. A tire formulation as set forth in claim 2 wherein the curing agent comprises ZnO and stearic acid.

10. A tire formulation as set forth in claim 2 wherein the cross-linking agent comprises sulfur.

11. A tire formulation as set forth in claim 2 further comprising an anti-ozonate.

12. A tire formulation as set forth in claim 2 further comprising an anti-oxidant.

13. A tire formulation as set forth in claim 2 wherein the calcium oxide is processed to nano level fine structures.

14. A tire formulation comprising:
natural rubber;
synthetic rubber;
carbon black;
a silane coupling agent;
a lubricant;
a curing agent;
a plasticizer;
a cross-linking agent;
an accelerator system;
a pre-vulcanization inhibitor; and
a filler derived from the calcination of egg shells.

15. A tire formulation as set forth in claim 14 further comprising silica.

16. A method of preparing a formulation for a tire comprising:
mixing a natural rubber, a synthetic rubber, carbon black, a silane coupling agent, a lubricant, a curing agent, a plasticizer, a cross-linking agent, an accelerator system, a pre-vulcanization inhibitor, and a filler derived from a bio-waste material;
forming the mixed tire tread formulation into a continuous slab by passing the mixed tire tread formulation through rollers;
wherein processing parameters comprising the duration for each stage, pressure, nip gap, speed of the rollers, their ratio or combinations of these are controlled.

17. The method as set forth in claim 16 wherein the derivation of the bio-waste material comprises calcinating egg shells by heating the egg shells to a temperature to drive off CO₂ and form solid CaO.
